(19) United States
(12) Patent Application Publication
(10) Pub. No.: US 2010/0162215 A1
(43) Pub. Date: Jun. 24, 2010

(54) ENABLING AUTOMATED REAL-TIME METRICS DURING THE SOFTWARE DEVELOPMENT PROCESS

(75) Inventors: SONYA PURCELL, CASHELL (IE); JAVIER RAMOS RODRIGUEZ, CASTLEKNOCK (IE); MARY K. SHAHEEN, WALPOLE, MA (US); SMRITI TALWAR, CLONSILLA (IE)

Correspondence Address: PATENTS ON DEMAND, P.A. - IBM CAM, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/337,781

(22) Filed: Dec. 18, 2008

(51) Int. Cl. G06F 9/44

(52) U.S. Cl. 717/127

(57) ABSTRACT

An event triggering an automatic real-time metric evaluation can be identified. A metric can be selected from one or more of metrics associated with the triggering event. Metric input can be collected from at least one source relevant to the selected metric. The collected metric input can be evaluated against one or more rules associated with the selected metric. The evaluation of the metric can be presented in real-time to an appropriate user. Based on the outcome of the evaluated metric, a programmatic action can be performed.

### BACKGROUND

The present invention relates to the field of software development and, more particularly, to enabling automated real-time metrics during the software development process.

Software engineers must constantly balance business-related problems and technical issues during designing and implementing a software product. Making intelligent decisions to solve these problems are key to successful development. Software metrics are often used to enable software engineers to make educated decisions by making the decision process less abstract and easier to understand. Metrics offer valuable insight into system performance, reliability, and usage patterns. Most companies, however, do not use software metrics at all. A lack of metrics makes it difficult to track an evolution of a system.

A fundamental problem with current application of metrics is they are typically utilized after development has been performed, which in agile methodologies occurs after each iteration. Often times, metrics slows down the development process because time is required to perform measurements. Since the metrics measurement process is not an automated process, developers are forced to manually invoke the appropriate metrics and measurement tools. As a result, many developers employ metrics at the end of development phases when making changes based on metrics can create new problems.

### BRIEF DESCRIPTION OF THE SEVERAL VIEWS OF THE DRAWINGS

FIG. 1 is a schematic diagram illustrating a system for automatically performing real-time metrics during a software development process in accordance with an embodiment of the inventive arrangements disclosed herein.

FIG. 2 is a schematic diagram illustrating a system for enabling self-managed real-time metrics throughout a software development process in accordance with an embodiment of the inventive arrangements disclosed herein.

FIG. 3 is a flowchart illustrating a method for automatically executing real-time metrics during a software development cycle in accordance with an embodiment of the inventive arrangements disclosed herein.

FIG. 4 is a schematic diagram illustrating an interface for managing a system capable of automatically performing real-time metrics throughout a software development process in accordance with an embodiment of the inventive arrangements disclosed herein.

### DETAILED DESCRIPTION

The present invention discloses a solution for enabling automated real-time metrics to be evaluated during the software development process. In the solution, a metrics engine can enable metric measurements to be taken and evaluated in real-time during one or more development phases. Engine can be associated with development applications such as Integrated Development Environments (IDEs), Control Versioning Systems (CVSs), and the like. Metrics can include software metrics, developer-related metrics, and the like. The measurement results can be evaluated in real-time against user-established rulesets. Based on the results of the evaluation, one or more actions can be performed by the engine. One action can include a notification action, which can be presented in real-time in response to the evaluation. Notifications can provide real-time feedback about development changes by informing and/or alerting a user of metric evaluation results. Metrics can be tracked throughout a development cycle and metric histories can be used to identify metric changes over time.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

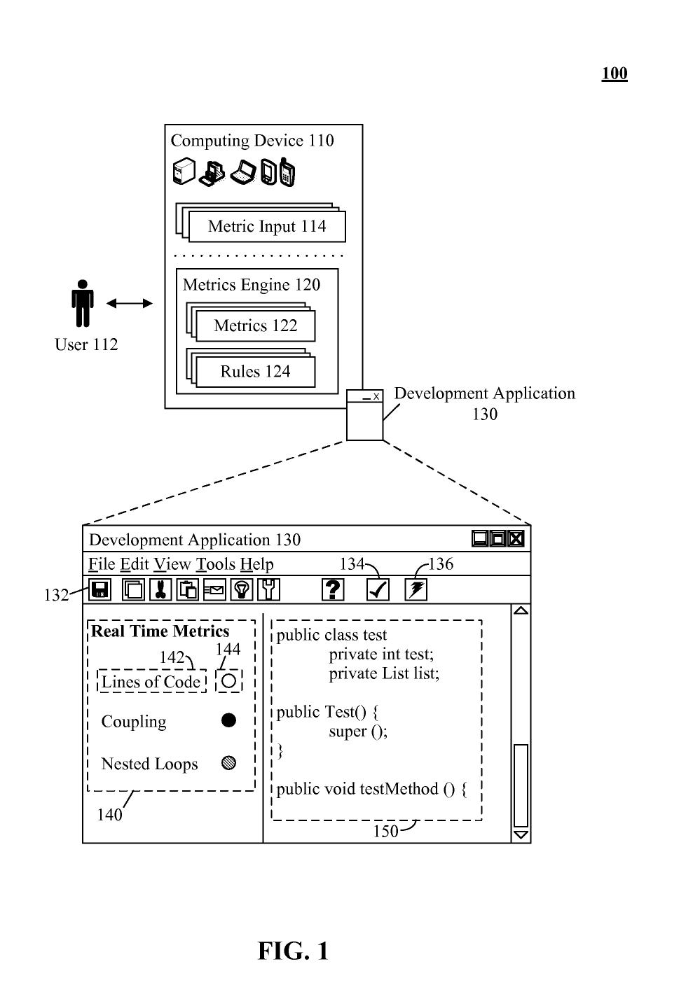

FIG. 1 is a schematic diagram illustrating a system 100 for automatically performing real-time metrics during a software development process in accordance with an embodiment of the inventive arrangements disclosed herein. In system 100, a computing device 110 utilizing engine 120 can perform real-time metric evaluations automatically on metric input 114. Development application 130 can execute metrics 122 in real-time on inputs 114 which can be source code 150. Metric execution can be triggered by one or more user 112 interactions with application 130. Interactions which can trigger metric evaluation can include, but are not limited to, save 132 functionality, execute 136 program code functionality, and the like. For instance, when user 112 saves source code 150, a “lines of code” metric can be evaluated and results can be presented in metric results 140.

As user 112 interacts with application 130, engine 120 can evaluate metrics 122 and present results 140 in real-time for each metric evaluated. The results 140 presented can include, but is not limited to, metric label 142, metric result indicator 144, and the like. For instance, when user 112 edits source code 150, engine 120 can update presented evaluated metrics information 142, 144. Metrics can be evaluated against rules 124 and one or more actions can be performed which can affect application 130 and user 112 interaction. For example, when user 112 executes code 150 that fails a performance metric, a code performance profiling tool can be presented.

Decisions about which metrics 122 are evaluated can be affected by user 112 interaction with application 130. For instance, during an editing phase, coupling metrics can be evaluated. Further, metrics execution can be triggered from other application 130 functionality such as copy/paste actions, line commenting, and the like. As each metric is evaluated, metrics 140 feedback can be updated to reflect the current state of metric input 114.

Metric results 140 can present results of metric evaluation of gathered metric input 114. Results 140 can include graphical presentation of metric results, textual information, interactive elements (e.g., hyperlinks), and the like. Presentation of results 140 can changed based on application 130 usage. For example, during editing source code 150, code level metric results 142, 144 can be presented. Metrics results 140 can permit user 112 to view relevant metrics and metrics criteria, enabling user 112 to adjust code 150 as necessary.

Visual indicator 144 can be utilized to denote results of metric evaluation. For example, when a metric 122 exceeds a rule 124, visual indicator 144 (e.g., colored circle) can be presented. Each metric in results 140 can behave according to application 130 settings, administratively configured settings, and the like. For instance, when a metric violates a rule 124 an indicator 144 can be presented as an empty circle or alternatively, indicator 144 can present a shaded circle when a metric exceeds a rule 124. Indicator 144 can be used to provide instantaneous metric feedback to user 112 enabling the user 112 to effectively use metrics during development.

Metrics engine 120 can be or can interact with a component of application 130. For instance, engine 120 functionality or a portion thereof can be encapsulated within a plug-in module able to interact with application 130. Alternatively, engine 120 can be a stand-alone executing application such as a system service, remotely executing service, and the like. In one embodiment, engine 120 can be a process thread executing within the application 130 automatically executing metric measurements in real-time based on metric input 114.

Development application 130 can include, but is not limited to, an Integrated Development Environments (IDEs). In one embodiment, application 130 can include a metric invocation mechanism such as a metric evaluation 134 functionality. For instance, application 130 can include an interface button which can enable user 112 to manually initiate metrics evaluation on source code 150. Metric evaluation 134 functionality can permit intelligent selection of metric evaluation based on application 130 configured settings. Alternatively, a dialog box presenting a set of relevant metrics can allow user 112 to target specific metric evaluations for code 150.

Drawings presented herein are for illustrative purposes only and should not be construed to limit the invention in any regard. As used herein, real-time can include near real-time performance of metrics evaluation. In one embodiment, metrics engine 120 can be a component of a metrics server able to interact with client computing devices (e.g., device 110). The application 130 can be presented in one or more contexts such as a graphical user interface (GUI), multimodal, voice user interface (VUI), and the like.

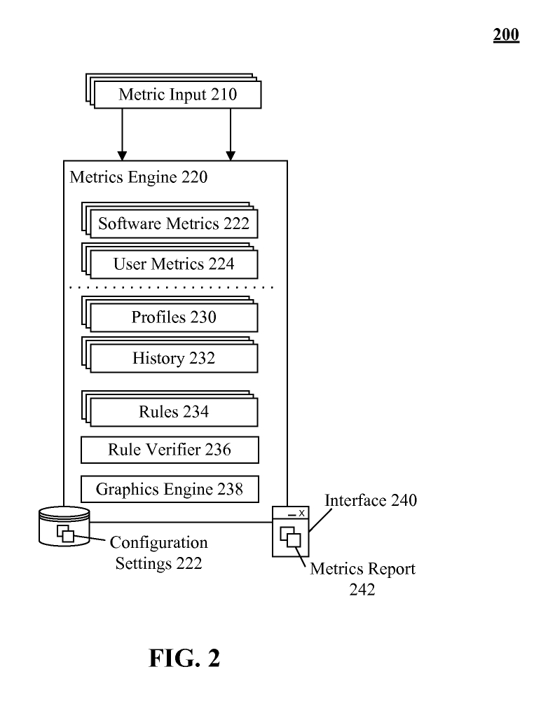

FIG. 2 is a schematic diagram illustrating a system 200 for enabling self-managed real-time metrics throughout a software development process in accordance with an embodiment of the inventive arrangements disclosed herein. In system 200, a metric engine 220 can facilitate the automated real-time evaluation of software 222 and user metrics 224 for metric input 210. Metrics 222, 224 can be measured in real-time using engine 220 framework allowing development to be continuously aided by metrics. Evaluated metrics can be presented in real-time as metrics report 242 via interface 240. Software developers can utilize instantaneous metric results 242 to improve software quality.

As used herein, input 210 can include data collected from source code, Unified Modeling Language (UML) data, executable program code, programmatic code comments, and the like. Input 210 can be automatically determined based on location information within a directory/file structure and/or can be user specified. For instance, all source code files within a directory structure can be automatically detected and subject to real-time metrics evaluation collection.

Software metrics 222 can be metrics able to measure a quality and/or quantity of one or more software elements. Software metrics 222 can include, but is not limited to, measurements such as cohesion, coupling, cyclomatic complexity, file size, lines of code, loop nesting, package dependency, number of methods, number of comment lines, Halstead metrics, and the like. Metrics 222 can include metrics from external sources (e.g., metric tools) which can be conveyed to engine 220. That is, metric input 210 can be measured by a system that operates independent of the metrics engine 220, which controls and handles results driven by metrics measured by a functionally independent system.

User metrics 224 can include developer specific metrics configured to determine developer progress. Metrics 224 can include, but is not limited to, written quantities of lines of code, methods, classes, comments, and the like. Metrics 224 can be associated with each developer based on developer role through profile 230 usage. For instance, software designer can be subject to design metrics evaluation while a programmer can be associated with code level metrics evaluation.

Profiles 230 can provide user specific tracking for metrics evaluation and metrics evaluation configuration. Profiles 230 can allow developers to configure customized metric execution, configure trigger mechanisms, associate metric evaluation actions and/or outcomes with metric tools, and the like. Further, profiles 230 can be used to establish tiered user security which can include users with multiple roles and configurable access permissions. In one embodiment, profiles 230 can be used to designate a user as an administrative user, supervisory user, privileged user, non-privileged user, and the like.

History 232 can be used to collect and track metrics throughout the development process. History 232 can provide metric information by user, metric type, metric input, development phase/cycle, class, package, component, code level metrics, and the like. History 232 can include past project metrics enabling direct metric comparisons with current project metrics. For instance, metrics from a previous revision of software can be compared to the current revision to determine potential performance degradation.

Rules 234 can direct metric evaluation and determine conditions for which metrics are met or violated. Rules 234 can include, but is not limited to, metric decisions rules, metric requirement criteria, metric outcome actions, and the like. For instance, administrative users can select a set of required metrics which must be met for a project. Rules 234 for meeting metric requirements can include maximum/minimum quantity of methods within a class, nested loops, lines of code, and the like. For example, a class metric can be configured to limit the number of methods within the class.

In one embodiment, rules 234 can be constructed from a specialized rule language able to designate verifier 236 behavior. In the embodiment, rules 234 can be an interpreted language script (e.g., Extensible Markup Language) enabling rules 234 to be written quickly and easily. Further, an interpreted language can allow portability and permit rules 234 to be human readable. Alternatively, rules 234 can be a compiled language format permitting rules 234 to be rapidly evaluated in real-time.

Rule verifier 236 can be used to determine the metric evaluation based on collected input 210. Rule verifier 236 can quantify collected data 210 and assess whether collected data is equivalent to criteria established in rules 234. For instance, verifier 236 can determine the number of lines of code within a module and compare the quantity to a line of code metric rule in rules 234. Based on the verifier 236 evaluation, an outcome can be enacted as determined by rules 234. For example, when a metric is evaluated and metric criteria is met, the metric can be temporarily suspended from being evaluated. When no action is determined in rules 234, default actions configured in settings 222 can be used.

Configuration settings 222 can enable the configuration of metric engine 220 behavior. Settings 222 can include administrative level configurations such as specifying required metrics, required metrics criteria, and the like. Settings 222 can affect how and/or when metric input 210 is collected and can be used to override user profile 230 settings. For instance, settings 222 can dictate periodic metric evaluations to be executed (e.g., every hour) throughout a development work-day.

Graphics engine 238 can compile and present metrics into visually presentable formats. Engine 238 can be used to present visual indicators of real-time metrics such as visual indicator 144 in system 100. Engine 238 can be an internalized component within metric engine 220 or can be an external framework engine associated with engine 220. For instance, engine 238 can be a graphics subsystem within a computing device able to present metric visualizations based on information conveyed by engine 220.

Metrics report 242 can be a real-time generated compilation of collected metric input 210 and/or metric evaluations. Report 242 can be generated at any time during a development process by automated or manual invocation. The report 242 can be presented in one or more common file formats including, but not limited to, XML, Hypertext Markup Language (HTML), and the like. Report 242 can be conveyed to interface 240 which can present report 242 to a user. Report 242 can include metrics from one or more phases of development, permitting an overview of metric outcomes for the development process. Further, report 242 can include a variety of metric information, including historical metrics, historical metrics of past projects, metrics from recent time segments of interest, and the like. Detailed information in report 242 can be user customizable and can include, but is not limited to, information about what metric was evaluated, metric evaluation time/date information, evaluation invoker, method of invocation, evaluation outcome, and the like.

Interface 240 can be utilized to view metrics information in real-time or near real-time. Interface 240 can include, but is not limited to, an Integrated Development Environment (IDE), Web browser, metrics application, visualization application, and the like. Interface 240 can be a component of metrics engine 220 or can be a stand-alone executing application able to communicate with interface 240.

Drawings presented herein are for illustrative purposes only and should not be construed to limit the invention in any regard. Functionality of system 200 can be represented as an Application Programming Interface (API) which can be implemented by any system able to interface with the API. System 200 and constituent components 220-242 can be present in the context of a distributed computing environment, networked computing environment, and the like. System 200 can be a collection of loosely coupled self-managed modules able to communicate with each other and/or other metric tools.

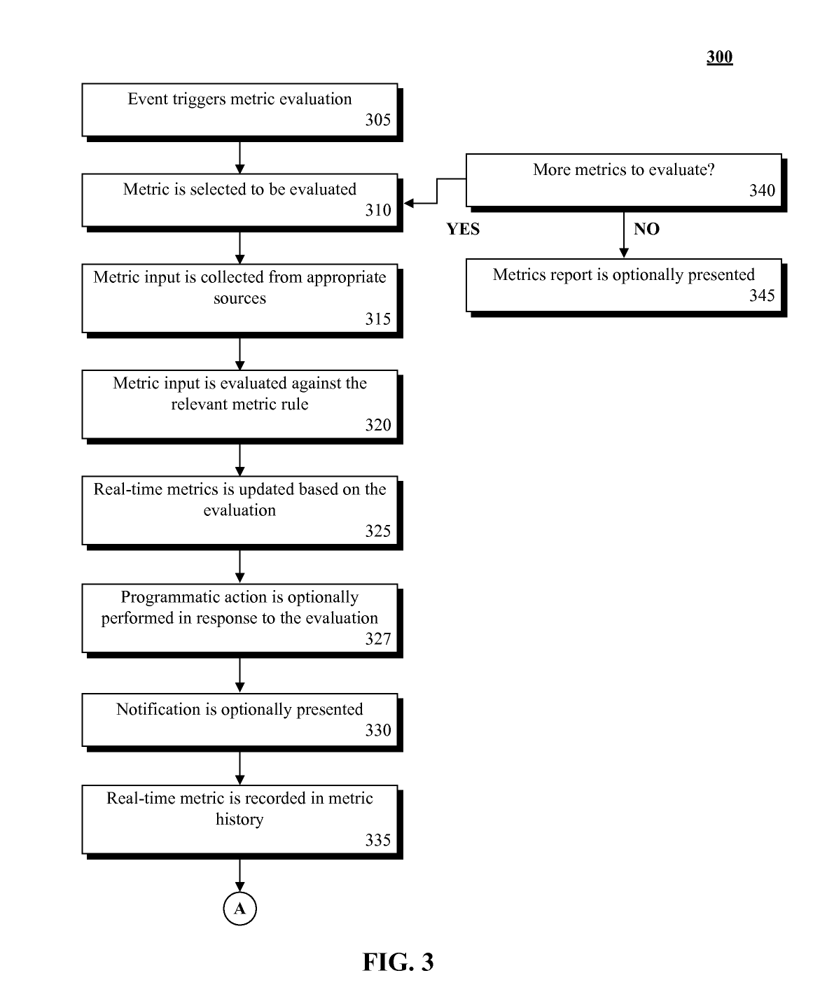

FIG. 3 is a flowchart illustrating a method 300 for automatically executing real-time metrics during a software development process in accordance with an embodiment of the inventive arrangements disclosed herein. Method 300 can be performed in the context of system 100, 200. In the method, a set of metrics can be automatically gathered during a software development process. For example, the metrics can be gathered automatically responsive to an occurrence of an event within an executing software application, such as an application being developed within a software development process. That is, the metrics can be gathered/generated serially or in parallel in response to one or more events. The metrics can be evaluated and results can be presented to a user. Alternatively, the results can be stored in a history without invoking a user presentation mechanism. Based on the results of the metrics evaluation, a programmatic action can be taken to assist a user in utilizing metrics.

In step 305, an event can trigger a metric evaluation to be performed in real-time. Events which can trigger metric evaluations can include, but are not limited to, user interaction with components associated with metrics evaluation, temporal events/conditions, execution of programmatic code, and the like. In step 310, a metric can be automatically selected to be evaluated from a set of appropriate metrics. The metric can be selected based on a user selection and/or programmatic decision based on rules. In step 315, input for the metric evaluation is collected from appropriate sources. Sources can include user defined sources, administratively defined sources, automatically determined sources, and the like. In step 320, the collected metric input is evaluated against a relevant metric rule. The rule can include, user defined rules, administratively defined rules, heuristically determined rules, rulesets, and the like.

In step 327, a programmatic action can be performed in response to the metric evaluation. The programmatic action can include, user defined actions, administratively defined actions, and the like. For instance, if a segment of executable code fails to meet a metric condition such as performance metric, a code profile optimization tool can be automatically presented. In one embodiment, the programmatic action can convey metrics in real-time to a metrics engine which can present a real-time view of a software development process. In step 330, a notification can be optionally presented based on the metric evaluation. Notification can include the presentation of an interactive interface dialog, visual notification, aural notification, and the like. In step 335, the real-time metric can be recorded in a metric history. In step 340, if more metrics can be evaluated, the method can return to step 310, else continue to step 345. The method can repeat steps 310-340 until appropriate metrics are no longer available. When all metric evaluations have been exhausted, the method can begin again after a system configured delay interval (e.g., twenty minutes) has been reached.

In step 345, a metrics report can be optional presented. The report can include, but is not limited to, metric information, graphical representation of metric information, metric histories, and the like. For instance, the metrics report can be a summation of metrics for a time segment of development. The metrics report can be optionally presented to administrative agents (e.g., project manager) in real-time enabling a real-time view of software development.

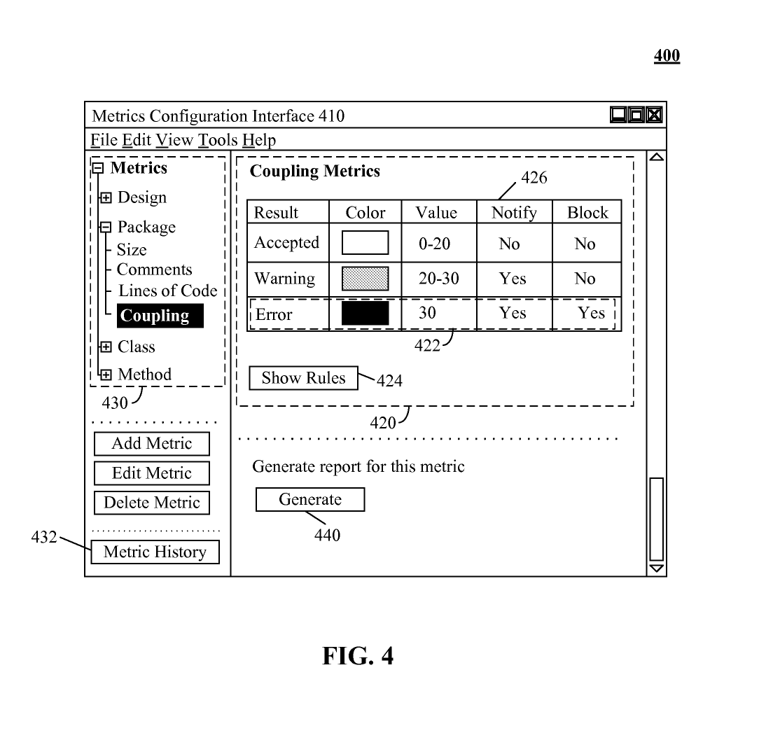

FIG. 4 is a schematic diagram illustrating an interface 410 for managing a system capable of automatically performing real-time metrics throughout a software development process in accordance with an embodiment of the inventive arrangements disclosed herein. Interface 410 can be presented in the context of system 100. Interface 410 can enable management of metrics and rulesets, presentation of metric history, and metric report generation. Depending on a user's permissions (e.g., view/modify), interface 410 can selectively present metrics 420. For instance, interface can be administratively configured to permit lead programmers to modify package level metrics but be unable to modify design metrics.

In interface 410 metrics hierarchy 430 can enable users to quickly navigate to important metrics. Hierarchy 430 can permit administrative users to lock segments of metrics management from non-authorized users. The hierarchy 430 can present, but is not limited to presenting, design metrics, package metrics, class metrics, method metrics, and the like. Hierarchy 430 can permit granular metric controls and management allowing individual alteration of a metric and ruleset. Further, administrators can modify metrics at the component level using hierarchy 430, enabling changes to be applied to all metrics within a metric parent (e.g., package metrics).

It should be noted that metrics can be handled as metadata. Therefore, even though the metrics framework can include a hierarchy 430 to define metrics, each metric can be implemented using different tools and methods, which measure the software. In other words, the application that controls and handles results based upon metrics can be independent of the measurement process.

Selection of a metric within hierarchy 430 can trigger presentation of metric configuration entities, as illustrated in section 420. Section 420 can present metric information, configuration parameters 422, ruleset information 424, and the like. For example, when a user selects the “package” entry in hierarchy 430, section 420 can present size metrics, comment metrics, lines of code metrics, and coupling metrics. Depending on the interface 410 configuration associated rules/rulesets can be presented simultaneously with user selected metrics.

Metric notification and action configuration of metrics can be achieved through elements within entity 426. Entity 426 can permit configuration of notification options and programmatic actions which can be enacted in response to a metric evaluation. For instance, entry 422 can cause a metric notification to be presented and access to a violating file/object can be restricted based on an erroneous metric evaluation.

Ruleset information for displayed metrics 426 can be further configured through a rules interface (not shown) from interactive artifact 424. Interaction with artifact 424 can trigger a rules management interface to be presented. The interface can permit rule modification, prioritization, and the like. Artifact 424 can permit rule information to be suppressed, presented, and/or modifiable based on a user's security settings.

Metric history can be presented through interaction with interface artifact 432. Metric history can include histories for all users, selected users, metrics by evaluated outcome, and the like. Metric history information can be graphically/visually presented in one or more forms including graphs, charts, diagrams, statistics, and the like. For instance, metric history can be presented as three-dimensional graph illustrating metric evolution over a development phase.

Information gathered from automatically performed real-time metrics can be aggregated into report form. Metric reports can be generated from interface 410 interactive element 440. Generated reports can customized based on user and/or system settings. Reports can be automatically conveyed to appropriate users (e.g., project managers) in real-time based on system configuration.

Drawings presented herein are for illustrative purposes only and should not be construed to limit the invention in any regard. Interface 410 can be presented in the context of a graphical user interface (GUI), multi-modal interface, voice user interface (VUI), textual interface, and the like. Interface elements 420-440 can vary from entities illustrated in interface 410. Functionality in interface 410 can be presented within interface elements which can include, but are not limited to, pull-down menu, context menu, pop-up dialogs, and the like.

The flowchart and block diagrams in the FIGS. 1-4 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for automated real-time metrics evaluation comprising:
automatically identifying an event configured to trigger a metric evaluation procedure, wherein the identified event is linked to at least one metric;
selecting a metric from a plurality of metrics associated with the triggering event, wherein the selected metric is one of a software metric and a user metric;
collecting metric input from at least one source relevant to the selected metric;
evaluating the collected metric input against at least one rule associated with the selected metric, wherein the evaluation is a comparison of a collected value and a previously stored value, wherein the previously stored value is associated with the rule;
presenting in real-time at least one result based on the evaluation of the metric; and
performing a programmatic action in response to the outcome of the evaluated metric.

2. The method of claim 1, wherein the triggering event is at least one of a user interaction and a temporal event.

3. The method of claim 1, wherein the result of the metric evaluation is visually presented.

4. The method of claim 1, wherein the presented result is used to track the progress of at least one of a software component and a user in real-time.

5. The method of claim 1, wherein the programmatic action is the modification of access privileges to a user accessible entity.

6. The method of claim 1, wherein the programmatic action is the automatic execution of a software metric tool associated with the metric evaluation outcome.

7. The method of claim 1, wherein the selected metric is a user customized metric.

8. The method of claim 1, wherein the method is performed in an integrated development environment (IDE).

9. A system for automated real-time metrics evaluation comprising:
a metric engine configured to automatically perform metrics evaluation in real-time on at least one of a set of metric inputs;
a rule verification engine configured to evaluate a metric based on at least one associated metric rule;
a data store configured to store a plurality of metrics, metric rules, and metric evaluation results, wherein the at least one metric evaluation result is linked to the a stored metric; and
a profile able to track at least one of a metric, metric rule, and a metric evaluation history.

10. The system of claim 9, wherein the metric rules is associated with at least one metric criteria value, notification action, and a programmatic action.

11. The system of claim 9, wherein the metrics is a user configured metric able to be automatically evaluated in real-time.

12. The system of claim 9, wherein the metrics is organized in a hierarchical structure, wherein an entity within the hierarchical structure is selectively configurable and is able to be evaluated.

13. The system of claim 9, wherein an administrative user can track the evaluated metrics of a non-privileged user in real-time.

14. The system of claim 9, wherein a metric evaluation result associated with at least one of a user and a software component can be presented in real-time.

15. A computer program product for improving remote procedure call performance comprising a computer readable storage medium having computer usable program code embodied therewith, the computer program product comprising:
computer usable program code configured to automatically identify an event configured to trigger a metric evaluation procedure, wherein the identified event is linked to at least one metric;
computer usable program code configured to select a metric from a plurality of metrics associated with the triggering event, wherein the selected metric is one of a software metric and a user metric;
computer usable program code configured to collect metric input from at least one source relevant to the selected metric;
computer usable program code configured to evaluate the collected metric input against at least one rule associated with the selected metric, wherein the evaluation is a comparison of a collected value and a previously stored value, wherein the previously stored value is associated with the rule;
computer usable program code configured to present in real-time at least one result based on the evaluation of the metric; and
computer usable program code configured to perform a programmatic action in response to the outcome of the evaluated metric.

16. The computer program product of claim 15, wherein the triggering event is at least one of a user interaction and a temporal event.

17. The computer program product of claim 15, wherein the result of the metric evaluation is visually presented.

18. The computer program product of claim 15, wherein the presented result is used to track the progress of at least one of a software component and a user in real-time.

19. The computer program product of claim 15, wherein the programmatic action is the modification of access privileges to a user accessible entity.

20. The computer program product of claim 15, wherein the programmatic action is the automatic execution of a software metric tool associated with the metric evaluation outcome.
